(19) United States
(12) Patent Application Publication
(10) Pub. No.: US 2004/0243456 A1
(43) Pub. Date: Dec. 2, 2004

(54) Method, device, computer-readable storage medium and computer program element for the monitoring of a manufacturing process of a plurality of physical objects

(76) Inventor: Jorn Maeritz, (US)

Correspondence Address: BRINKS HOFER GILSON & LIONE, P.O. BOX 10395, CHICAGO, IL, 60610, US

(21) Appl. No.: 10/706,608

(22) Filed: Nov. 12, 2003

(30) Foreign Application Priority Data
Nov. 12, 2002 (DE) 102 52 608.7

(51) Int. Cl. G06F 17/60

(52) U.S. Cl. 705/8

(57) ABSTRACT

A method and device for the monitoring of a manufacturing process of a plurality of physical objects are disclosed. A method for the monitoring of a manufacturing process of a plurality of physical objects in which a statistical analysis is performed by using values of at least one process parameter of the manufacturing process of the physical object. Furthermore, in the case of the method, when they do not satisfy a prescribed selection criterion as a result of the statistical analysis, physical objects are marked in such a way that the associated physical objects are to be sent for special treatments.

The invention relates to a method and a device for the monitoring of product quality data in a manufacturing process.

In the manufacture of wafers with highly integrated semiconductor chips, the ever-increasing miniaturization of the structures on the semiconductor chip are responsible in particular for imposing ever greater requirements on the production installations and manufacturing processes used for the manufacture of the semiconductor chips. The stability and reproducibility both of the production installations and of the manufacturing processes decisively influence the yield and productivity during semiconductor chip production. Even small deviations from a prescribed form of behavior of a chip production installation during production can lead to considerable worsening of the yield (i.e. a considerable increase in the defect rate of the semiconductor chips manufactured).

For quality management, that is to ensure the quality of the manufacturing process and the quality of the wafers, the wafers must be subjected to test measurements once processing of them has been completed. To monitor and assess the manufacturing process completely, it is necessary to test each individual wafer which has been produced by means of the manufacturing process and subsequently to assess the quality of the wafer. However, this is not possible on account of the time-intensive and cost-intensive test measurements for determining the quality of the wafers.

For quality management, the “Statistical Process Control” (SPC) method is often used. According to this method, wafers selected as random samples are tested for their quality by means of test measurements and, on the basis of the results of the investigations of the random samples, the product quality of entire lots of a manufacturing process is concluded. The samples are in this case taken randomly from the wafers of a lot. By means of this SPC method, the average quality of the wafers of a lot or of a manufacturing process is determined.

In quality management, it is necessary not only to determine the average quality of the wafers of a lot but also to segregate wafers which are of a low quality and consequently do not satisfy a prescribed quality criterion, and send them for special treatment, i.e. for a special measurement and possible re-working. For this purpose it is necessary to determine those wafers of a lot that are at risk of not satisfying the prescribed quality criterion because faults occurred during their processing in the manufacturing process. For this purpose, the “Fault Detection and Classification” (FDC) method is often used. By means of this method, process faults, i.e. faults which have occurred in the manufacturing process, are registered. The corresponding defects are referred to in the application as FDC defects.

The detection of wafers which do not satisfy the quality criterion should also be performed as early as possible and as reliably as possible in the manufacturing process, in order to notice a possible problem in the manufacture as early as possible. In addition, it is desirable that a wafer which has been defectively processed does not remain in the customary process sequence without special treatment, but is removed from it.

This is ensured according to the prior art by a control supervisor or engineer, who decides on the basis of a multiplicity of parameters observed by him which wafer is to be sent for special treatment and what else is to happen with the corresponding wafer. For this purpose, the control supervisor must react within a short time period after the provision of the parameters of the manufacturing process and perform a corresponding special measurement. However, it is not ensured in this way whether the multiplicity of parameters will reach the control station in time for a special measurement that is possibly required to be initiated. This may have the effect that wafers which should actually be sent for special treatment before further processing. Late detection of faults in the manufacturing process can also occur, and consequently a rise in production costs.

German Patent DE 198 47 631 A1 discloses a quality management system in which a data processing unit processes a data value measured by a defect inspection device, such as for example the number of defects, a surface area of each defect, an equivalent diameter of the surface area, etc., in such a way that index values are calculated as processed data values and used by a judgment unit as a basis for judging whether or not further testing is to be carried out.

The invention is based on the problem of increasing the yield of the wafer manufacturing process and improving the quality of the wafers.

In the case of a method for the monitoring of a manufacturing process of a plurality of physical objects, an analysis is performed by using values of at least one process parameter of the manufacturing process of the physical object. As a result of the analysis, when they do not satisfy a prescribed selection criterion, physical objects are identified in such a way that the associated physical objects can be sent for special treatment. In other words, on the basis of the selection criterion, the respective physical objects on which a special measurement should be carried out before further processing are marked.

A process parameter is to be understood in this connection as meaning a parameter of a manufacturing process of a physical object. These include, for example, in the manufacture of a wafer the misalignment, the inaccuracy of the positioning of a wafer in a machine (or in other words a deviation of an actual position of the wafer in the machine from the prescribed position of the wafer in the machine, within a positioning step), the temperature during a process step, the gas flow during a process step, the time duration of a process step, the pressure prevailing during a process step, generally all valve positions, a wafer carrier speed and a wafer carrier contact pressure. Other process parameters in lithography are, for example, various alignment variables, a focusing or a dose. These process parameters are constantly recorded during the manufacturing process and are available for an analysis.

The analysis may be a statistical analysis. It may, however, also investigate individual values or evaluate simple statements, for example whether or not a physical object satisfies a certain requirement (such as good or no good).

The device for the monitoring of a manufacturing process of a physical object has at least one processor, which is set up in such a way that the method steps described above can be carried out.

In a computer-readable storage medium, a computer program for the monitoring of a manufacturing process of a physical object is stored. The computer program implements the method steps described above when it is run by a processor.

A program element for the monitoring of a manufacturing process of a physical object implements the method steps described above when it is run by a processor.

The invention can be realized both by means of a computer program, i.e. software, and by means of one or more special electrical circuits, i.e. in hardware, or in any desired hybrid form, i.e. by means of software components and hardware components.

The invention has the advantage that, by means of the analysis of the process data, a selection criterion is provided, by means of which it can be determined which physical objects of a plurality of physical objects are identified, so that they can be sent for special treatment. The selection of the physical objects which must be sent for special treatment is consequently no longer performed by a control supervisor or engineer, but automatically. This prevents the possibility of a message from the FDC method concerning a defectively processed physical object from arriving too late at the appropriate location. The method according to the invention, also ensures that it is possible to react to information of an FDC method, i.e. information concerning processing faults in the manufacturing process, within a prescribed time period. This is not possible according to the prior art.

Preferred developments of the invention emerge from the dependent claims. The further refinements of the invention relate to the method and the device for the checking of the manufacturing process of a physical object, to the computer-readable storage medium in which a program for the monitoring of a manufacturing process of a plurality of physical objects is stored and to the program element for the monitoring of a manufacturing process of a plurality of physical objects. The physical object is preferably a wafer.

The invention is well-suited in particular in the case of wafer manufacture with its extremely high number of process steps, with very high requirements on the accuracy of the setting of the process parameters, since an automated, improved quality control is realized in a simple way for the first time in this area. In a preferred development, the analysis is a statistical analysis.

Furthermore, in the case of the method according to the invention, the values of the at least one process parameter are measured when the physical object is being manufactured.

According to one refinement, at least one marked physical object is sent for a special measurement.

According to one development, the special measurement is a measurement for checking the quality of the physical object marked.

The physical objects not marked can be further treated according to the manufacturing process, without being sent for the special measurement.

The selection criterion is preferably a quality characteristic of the manufacturing process, i.e. a selection criterion which indicates the maintenance of certain process conditions and consequently the quality of the manufacturing process carried out.

In one development, the selection criterion is considered as not satisfied if a value of the at least one process parameter goes above or below a prescribed limit value, i.e. the physical object is marked when the parameter goes below a lower threshold value (limit value) or exceeds an upper threshold value. The threshold values preferably being specified as relative threshold values, i.e. the deviation must not be greater than a prescribed percentage value of the mean value, or preferably as absolute threshold values, i.e. a fixed prescribed threshold value above and below which the parameter must not go is specified.

Consequently, it is possible according to the invention to combine the FDC method and the method for carrying out special treatments into a common automated method. By contrast with the prior art, it is envisaged to respond in sufficient time and with the necessary reliability to process faults noticed in the FDC, i.e. to carry out a special measurement and possible re-working of the object, in particular the wafer. Furthermore, it is ensured by the method according to the invention that the message concerning a processing fault which has occurred reaches the control station in good time, that the results of the special measurements do not go into the normal SPC system and that the lot of wafers in respect of which a processing fault has occurred is not identified by the SPC method as a lot which is logged in measuring operations for testing in a next operation, i.e. the next method step of the manufacturing process. The invention provides an automatic system by means of which rules of the FDC method and of the random sample selection are linked with one another. In exemplary embodiments of the invention it is ensured by means of a set of rules that two aspects which are to be considered in the further treatment of the lots with processing defects are satisfied. On the one hand, such lots do not remain in the normal manufacturing process beyond the measuring operations if no SPC measurement is to be carried out, but are registered for special measurements. On the other hand, it is ensured that, if a random sample from the lot concerned is to be investigated for the SPC method, no wafer from this lot in which an FDC defect has occurred is proposed for the SPC measurement, and the wafers in respect of which an FDC defect has occurred are registered for the special measurement. In this way it is ensured that no outliers, i.e. wafers in respect of which processing faults (FDC defects) have occurred, enter the SPC quality management and that no wafers with FDC defects reach the next operation (manufacturing process step), without at least having been sent for a special measurement.

The invention provides a measuring concept, i.e. a concept for all measurements (SPC measurements and special measurements), which is linked with the FDC method and the information obtained from it concerning FDC defects which have possibly occurred.

Consequently, an improvement of the quality management and improved product control by means of a higher degree of automation of the sample selection are obtained as advantages of the method according to the invention.

Even though the invention is explained in more detail below on the basis of the example of a monitoring method of a wafer manufacturing process, it is pointed out that the invention is not restricted thereto but instead can be used in all monitoring methods for manufacturing processes in which process parameters are recorded in the manufacturing process, for example also in the pharmaceuticals industry in the manufacture of pharmaceutical products.

An exemplary embodiment of the invention is explained in more detail below and represented in the figures, in which:

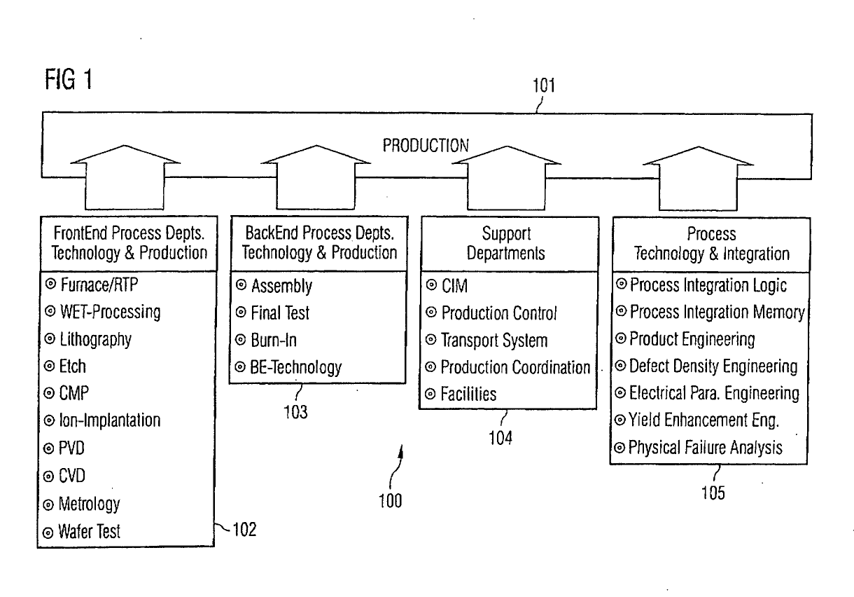

FIG. 1 shows a block diagram in which the general organization of a chip production installation is represented;

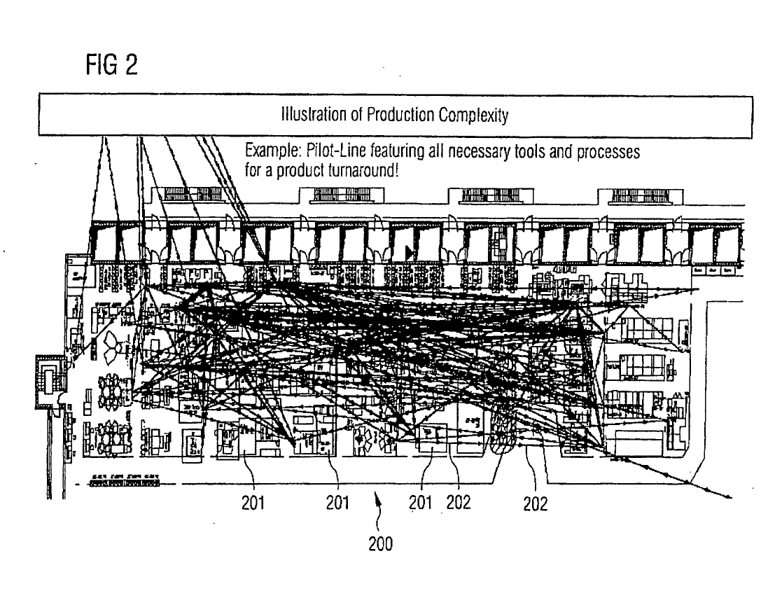

FIG. 2 shows a diagram of a chip production installation, with the complex material flow, i.e. the path of a wafer/lot, through the chip production installation and the associated complex process steps being represented;

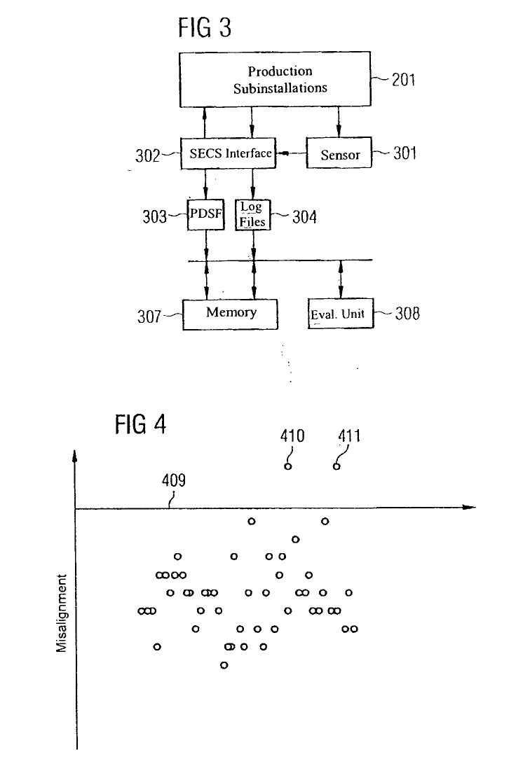

FIG. 3 shows a block diagram in which the process data flow when producing a wafer/lot is represented; and

FIG. 4 shows a distribution of values of a process parameter which is used as a selection criterion in a statistical analysis.

By way of introduction, FIG. 1 schematically illustrates in a block diagram 100 the organization and setup of a semiconductor chip production installation, for which a method according to the invention can be used for the monitoring of a manufacturing process of a plurality of wafers.

The overall manufacturing process, referred to in FIG. 1 by a first block 101, is grouped by way of example into four production areas 102, 103, 104, 105,

a first area, into which the front-end processes of the chip production are grouped (block 102);

a second area of the manufacturing process, into which the back-end processes are grouped (block 103);

a third area of the manufacturing process, which relates to the support, that is to say the backup, of the individual manufacturing processes (block 104);

a fourth area, which relates to the process technology and the process integration (block 105).

In the case of the front-end processes 102, the following process technologies and the devices set up for carrying out the corresponding processes are provided in particular:

a furnace for heating up the respective wafer to be processed;

a device for carrying out Rapid Thermal Processing (RTP);

a device for etching the wafer, for example for wet-etching or for dry-etching;

a device for cleaning, for example washing, the wafer;

a device for carrying out various lithographic steps;

a device for chemical-mechanical polishing (CMP);

a device for carrying out an ion-implantation in predetermined areas of the wafer or of the chip respectively to be produced;

devices for applying materials to the wafer, for example devices for depositing materials from the vapor phase, that is for example devices for carrying out Physical Vapor Deposition (PVD) or Chemical Vapor Deposition (CDV), or a device for epitaxially growing material on a substrate;

metrology devices, i.e. measuring devices; and

devices for carrying out tests on the respective wafers.

The back-end processes relate in particular to the following areas:

the assembly of the chips in packages;

the final test of the finished and packaged chip;

the introduction of information, for example product information, into or onto the package of the respective chip; and also

generally the technologies used in the back-end area for packaged and unpackaged chips.

The support, that is to say the process backup, relates in particular to the following areas:

CIM;

process monitoring;

a transportation system for delivering the finished semiconductor chips;

coordination of production; and

backup for the respective production sites.

Process technology and process integration relates in particular to

the process integration of logic chips;

the process integration of memory chips;

product engineering;

the monitoring and improving of defect densities in manufacture;

the monitoring of electrical parameters in the products manufactured;

enhancement of the yield of the chips manufactured; and

a physical failure analysis.

FIG. 2 shows a semiconductor chip production installation, such as a semiconductor chip factory 200, with a multiplicity of semiconductor chip production sub-installations 201, which are used for processing raw materials, for example a silicon wafer or a wafer made of other semiconductor materials (germanium, gallium-arsenide, indium-phosphide, etc.), in order to produce semiconductor chips from the raw materials.

A customary manufacturing process for manufacturing a semiconductor chip has hundreds of different process steps, in which lithographic steps, etching steps, CMP steps, steps for applying materials to the respective wafer to be processed, or else steps for doping or implanting doping atoms in the wafer to be processed are carried out in various sequences. In the case of all these process steps, values of process parameters which can be subjected to a later statistical analysis are recorded.

The results in the paths represented in FIG. 2 by lines 202, which represent the path of a wafer or lot of wafers through the semiconductor chip production installation 200. In the semiconductor chip production installation 200, there are a multiplicity of sensors, which are assigned to the respective sub-production installations 201 and an even greater amount of process data (raw data), which are respectively acquired by the sensors and processed as explained in more detail below, are recorded. A respective sensor may be integrated into a respective machine (integrated sensor) or may be attached separately to a respective machine (external sensor).

Hereafter, the production sub-installations 201 are also referred to as machines 201.

FIG. 3 shows by way of example the data flow for process data, which are acquired on a machine 201 by means of an integrated sensor or by means of an external sensor 301. Because it is possible for any desired number of integrated and/or external sensors to be provided, each sensor 301 acquires the parameters of the machine 201 which are respectively predetermined for it, for example physical or chemical states in a process chamber, the position of a robot arm, etc. Examples of process parameters in the manufacture of a wafer are the misalignment (i.e. the positioning inaccuracy, within a positioning step), the temperature during a process step, the gas flow during a process step, the time duration of a process step or the pressure during a process step.

The sensor 301 is coupled via an SECS interface 302, which is set up for data communication according to the SECS standards, to a local communication network (Local Area Network, LAN) 306.

According to the SECS standards, files are generated by the sensor 301 and the SECS interface 302 according to the PDSF format (Process Data Standard Format), also referred to hereafter as PDSF files 303 or log files 304, the PDSF files 303 and the log files 304 are preferably stored as data in a memory 307.

The PDSF files 303 contain, for example, analog data from different channels, that is to say from different internal (i.e. integrated) and/or external sensors 301, which may be attached to a machine 201. The process data generated are stored in the memory 307.

The memory 307 stores the process data in such a way that they can be assigned to the wafers after completion of the wafers and makes the process data available for later statistical analysis. The statistical analysis is carried out by means of an evaluation unit 308. The statistical analysis of the evaluation unit 308 serves the purpose of providing a selection criterion with the aid of which wafers of a lot which have an FDC defect are not used as a random sample for a subsequent SPC measurement, but instead are subjected to a special treatment before further processing.

Represented in FIG. 4 is a distribution of the values of a process parameter which were recorded in the manufacturing process of a wafer. These values are obtained by means of an FDC method. Chosen as an example was a process parameter which shows the misalignment, i.e. the deviation in the X and/or Y direction from a prescribed position of the wafer, which prescribed position it is intended to assume during processing. The process data represented are on-line process data of a lot in lithography. The process data are acquired during the manufacturing process by an exposure machine and transmitted by means of a LAN network. The variation of the values of the process parameter which can be seen in FIG. 4 shows the natural process variation, i.e. the variation of the alignment quality of the wafers.

The value of the misalignment is determined as a process parameter for each wafer, as described above. It is consequently available without further time-consuming and costly measurement. The distribution of the values of the misalignment of all the wafers of a lot which is to be characterized by means of a quality monitoring test is created by means of a statistical analysis.

In the exemplary embodiment, the misalignment values (process parameters) of all the wafers are entered in a diagram in the statistical analysis. This produces a two-dimensional histogram in which the misalignment values of the wafers are plotted against the wafer numbers. Furthermore, the mean value or median of the process parameter of all the wafers of the lot is calculated by means of the statistical analysis for the case of a relative limit, i.e. a limit which relates to the mean value or median of the investigated process parameter of the wafers of the lot, and likewise entered in the two-dimensional distribution. On the basis of this two-dimensional distribution and the corresponding limit value, it can then be investigated by means of the analysis which wafers exceed a misaligned limit value and which do not. In the case of an absolute limit value, there is no need for the calculation of the mean value or median in the statistical analysis.

In FIG. 4, the values from the FDC method for a lot comprising 50 wafers are entered. Additionally depicted in FIG. 4 is a limit value 409, which must not be exceeded by the misalignment value measured for a wafer. According to the invention, the threshold value may either be a relative threshold value (limit value), i.e. a threshold value (limit value) which indicates by how many percent a process parameter may go above or below a set value prescribed for it, or an absolute threshold value, i.e. a threshold value above and below which the corresponding process parameter must not go. The relative threshold value may also be prescribed with respect to the median or the mean value of the distribution. By means of the analysis, wafers which go below or above prescribed threshold values are then determined. In the example of the misalignment, it is investigated by means of the analysis which wafers exceed the limit value 409. In FIG. 4, the wafers 410 and 411 exceed the corresponding limit value 409 of the misalignment. These two wafers are then marked in such a way that they are recognizable as wafers which must be sent for a special measurement and which must not be sent for an SPC measurement for determining the average product quality. They are consequently removed from the normal further manufacturing process. It is consequently ensured in the exemplary embodiment that a wafer in respect of which an FDC defect has occurred during its manufacture cannot serve as a random sample for an SPC measurement. This must be ruled out, since the wafer is not representative of the lot or the manufacturing process.

Consequently, the average product quality determined in this way cannot be influenced by means of this removed wafer. On the other hand, the marked wafers are subjected to a special measurement in the measuring concept, in order to investigate whether or not they correspond to a quality criterion in spite of the FDC defect. Depending on the result of this special measurement, the marked wafers are either rejected, re-worked or, if it is found by means of the special measurement that the FDC defect had no influence on the wafer quality, re-introduced into the customary manufacturing process without additional steps.

A special measurement is understood in connection with the quality monitoring of wafers as meaning that the wafers which are sent for a special measurement are sent for a test measurement which determines the actual quality of the wafer. The occurrence of an FDC defect alone does not necessarily lead in a manufacturing process to the wafer not satisfying the quality criteria. Even wafers with respect to which FDC defects have occurred during their manufacture can satisfy the quality criteria. However, in the case of wafers with respect to which an FDC defect occurred during their manufacture, there is the risk that they do not satisfy the quality criteria. In order to prevent these possibly defective wafers from continuing to remain in the manufacturing process unchecked, the special measurement, i.e. test measurement, is carried out for product quality determination.

According to the exemplary embodiment, a random sample selection for the SPC method in the case of the occurrence of an FDC defect is influenced in the following way. Firstly, a wafer of a lot with respect to which an FDC defect has occurred on said wafer must not bypass the measuring operations of a measuring concept, but instead is registered for a special measurement, even if a random sample from this lot is to be sent for an SPC measurement. Secondly, if a random sample from this lot is to be registered for the SPC measurement, a wafer with respect to which an FDC defect has occurred during its manufacture is not selected, but instead the wafers with respect to which an FDC defect has occurred are registered for a special measurement and a wafer with respect to which no FDC defect has occurred during its manufacture is selected for the SPC measurement.

It is consequently ensured that a representative wafer is selected for determining the average quality of the wafers and of the manufacturing process, i.e. the lot and the manufacturing process are correctly characterized, whereas wafers with respect to which an FDC defect has occurred during the manufacture cannot remain in the normal manufacturing process without a special measurement.

On the basis of the result of the special measurement, i.e. the test measurement for determining the quality of the wafer, it is decided how the wafer concerned is further processed. If it is found that the FDC defect has no influence on the quality of the wafer, it is re-introduced into the normal manufacturing process. If it is found that the FDC defect had effects on the quality of the wafer, it is decided whether the wafer can be re-introduced into the normal manufacturing process after re-working, or whether re-working is not possible or appropriate and the wafer is segregated as faulty.

To sum up, the invention provides a method and a device for the monitoring of the product quality (quality management) of a physical object in a manufacturing process in which an FDC method and a general measuring concept which comprises SPC measurements and special measurements are linked to form an integral concept. In this way, the susceptibility of the quality management to errors is reduced. By means of a set of rules, the measuring concept automatically responds to information of the FDC method, without a control supervisor or engineer having to exert any influence. The monitoring of the production quality is consequently improved.

The following document is cited in this document:

[1] DE 198 47 631 A1

1. A method for the monitoring of a manufacturing process of a plurality of physical objects, the method comprising the steps of:
performing an analysis by using values of at least one process parameter of the manufacturing process of the physical object;
determines when they do not satisfy a prescribed selection criterion; and
marking the physical objects in such a way that the associated physical objects are to be sent for a special measurement.

2. The method as claimed in claim 1, in which the physical object is a wafer.

3. The method as claimed in claim 1 or 2, in which the analysis is a statistical analysis.

4. The method as claimed in one of claims 1 to 3, in which the values of the at least one process parameter are measured when the physical object is being manufactured.

5. The method as claimed in one of claims 1 to 4, in which at least one marked physical object is sent for a special measurement.

6. The method as claimed in claim 5, in which the special measurement is a measurement for checking the quality of the physical object marked.

7. The method as claimed in one of claims 1 to 6, in which the physical objects not marked are further treated according to the manufacturing process.

8. The method as claimed in one of claims 1 to 7, in which the selection criterion is a quality characteristic of the manufacturing process.

9. The method as claimed in one of claims 1 to 8, in which the selection criterion is considered as not satisfied if a value of the at least one process parameter goes above or below a prescribed limit value.

10. A device for the monitoring of a manufacturing process of a plurality of physical objects with a processor which is set up in such a way that the following method steps can be carried out:
performing an analysis by using values of at least one process parameter of the manufacturing process of the physical object;
marking of physical objects when, as a result of the analysis, a prescribed selection criterion is not satisfied; and
sending the associated physical objects for special treatments.

11. A computer-readable storage medium, in which a program for the monitoring of a manufacturing process of a plurality of physical objects is stored, which program performs the following method steps when it is run by a processor:
performing analysis by using values of at least one process parameter of the manufacturing process of the physical object;
marking of physical objects when, as a result of the analysis, a prescribed selection criterion is not satisfied; and
sending the associated physical objects for special treatments.

12. A computer program element for the monitoring of a manufacturing process of a plurality of physical objects, which has the following method steps when it is run by a processor:
performing an analysis by using values of at least one process parameter of the manufacturing process of the physical object;
marking of physical objects when, as a result of the analysis, a prescribed selection criterion is not satisfied; and
sending the associated physical objects for special treatments.
